(19) United States
(12) Patent Application Publication
(10) Pub. No.: US 2002/0009285 A1
(43) Pub. Date: Jan. 24, 2002

(54) Personal versatile recorder: enhanced features, and methods for its use

(75) Inventors: Reem Safadi, Horsham, PA (US); Mark DePietro, Harleysville, PA (US); Christopher Seymour, Hatfield, PA (US); Sal Macera, Maple Glen, PA (US); Ed Zylka, Blue Bell, PA (US); Stan Elias, North Wales, PA (US)

Correspondence Address: RADER FISHMAN & GRAUER PLLC, LION BUILDING, 1233 20TH STREET N.W., SUITE 501, WASHINGTON, DC, 20036, US

(73) Assignee: General Instrument Corporation

(21) Appl. No.: 09/931,465

(22) Filed: Aug. 17, 2001

Related U.S. Application Data
(63) Continuation-in-part of application No. 09/810,667, filed on Mar. 19, 2001.
Application No. 09/810,667 is a continuation-in-part of application No. 09/520,968, filed on Mar. 8, 2000.

(51) Int. Cl. H04N 5/92; H04N 7/00

(52) U.S. Cl. 386/46; 386/83

(57) ABSTRACT

Described are a method and apparatus to enhance the use and recording features of the personal versatile recorder. The personal versatile recording includes plurality of tuners, wherein the content is individually selectable by each tuner of the plurality of tuners. When a first tuner of the plurality of tuners is tuned to an original channel to select original channel content for viewing, the original channel is the viewed channel. The original channel content is cached while presenting the original channel content for viewing. A second tuner of the plurality of tuners may be tuned to at least one subsequent channel to select subsequent channel content for viewing while simultaneously caching the original channel content for subsequent viewing. Other capabilities include annotation, frame cropping, graphical manipulation and storage, segment recording, automatic recording based on advertised content, and prevention of unauthorized disk portability and usage.

### RELATED APPLICATIONS

This application is a Continuation-in-Part of U.S. patent application Ser. No. 09/810,667 entitled, “Personal Versatile Recorder: Enhanced Features, And Methods For Its Use,” filed on Mar 19, 2001, which is a Continuation-in-Part of U.S. patent application Ser. No. 09/520,968 entitled, “Personal Versatile Recorder And Method Of Implementing And Using Same,” filed on Mar 8, 2000.

### FIELD OF THE INVENTION

The present invention relates to the field of multimedia recording and playback. More specifically, the present invention relates to a personal versatile recorder for connection to a communication network. The personal versatile recorder of the present invention is used for recording, transcoding, retrieval, and playback of audiovisual programming and caching of either streaming data or a wide variety of multimedia data files and formats, including, but not limited to, compressed audiovisual files, HyperText Markup Language (HTML) files, audio files, video or picture files, electronic mail (e-mail), or any combination of the above, facilitating a wide variety of real time and non-real time applications.

### BACKGROUND OF THE INVENTION

Television is widely used in modern society as a source of both information and entertainment. Multiple-channel programming networks, such as high bandwidth cable, multi-channel broadcast television, direct broadcast satellite, multi-channel multi-point distribution service, satellite master antenna television, and the like, supplement over-the-air broadcast systems to provide dozens or even hundreds of additional channels of programming to a viewer. Additionally, the current trend is for multiple-channel programming networks to provide additional services such as Internet access.

The multiple systems operator (MSO) distributes premium television programming over a multiple-channel programming network for a subscription fee. While such programming provided to the viewer includes premium channels, it also includes pay-per-view programming. Pay-per-view programming is a technique used by the MSO to offer premium programming to its system subscribers. Using this technique, the particular event is selected and individually purchased by the subscriber for an additional fee. Depending upon the operation and administration of the multiple-channel programming network, a pay-per-view program (also known as a pay-per-view event) can be purchased using payment systems that include, but are not limited to, customer service representatives, automated response units, impulse-pay-per-view, or video-on-demand.

When a customer service representative is used to order pay-per-view programming, the subscriber places a telephone call to a service center and the representative answering the call will place the order into the system. But when an automated response unit is used, although the subscriber places a telephone call to a service center, the call is automatically answered and processed, typically by a computer. Impulse pay-per-view allows the subscriber to purchase the event without placing a call to a service center. Instead, the event can be purchased in the home from an event menu shown on the television screen. When video-on-demand is alternatively used to order an event, that event is presented to the subscriber for immediate viewing, regardless of the placement time of that order.

The shear volume of available programming causes difficulties for the viewer. For example, two programs the viewer wishes to watch could be broadcast simultaneously. Also, a program the viewer wishes to see could be broadcast at an inconvenient time. These problems are overcome by recording devices such as a video cassette recorder (VCR).

A VCR allows the user to record incoming audiovisual programming while watching a different channel. The VCR also allows the user to record programming when the user is away and cannot watch the desired programming. Consequently, the VCR allows the user to capture programming that would otherwise be missed, so that that programming is viewed at the user's convenience.

The basic concept of the VCR has recently been extended to digital compression devices that provide even more features for managing the reception and recording of audiovisual programming. These products have a number of names such as personal television products, personal video recorders, video recording computers, personal television servers, and the like, referred to hereinafter as “personal video recorders”. Current examples of personal video recorders include the TiVo® system made by TiVo, Inc. and the ReplayTV® system made by ReplayTV, Inc.

In even more advanced features, the personal video recorder can be programmed on a manual or timer-controlled basis to regularly record a user's favorite programs, and then also record other programs of the same genre that the user may be interested in watching. Thus, the personal video recorder may assist a user in viewing audiovisual programming that the user is interested in, but unaware of, at the time of its broadcast.

While the personal video recording system offers many advantages over the conventional video cassette recorder, there are still shortcomings in the personal video recorders presently available. For example, programming events having variations in the starting time or ending time from the originally posted time (such as live sporting events) pose a challenge when the consumer wishes to record such events. Specifically, when the broadcast time period for a program unexpectedly extends beyond the expected time period, the consumer typically records the program for the expected time period only to discover that the program segment that has aired during the additional time period was not recorded. Thus, when the program overruns or exceeds its allotted time slot, extra recording time must be added to ensure that the entire program is recorded. With some personal video recording devices, the consumer can manually and arbitrarily enter the start and stop times in attempting to compensate for these programming schedule variations. However this is not optimal since this approach does not guarantee the recording of the program segment that has aired during the additional time period, or it may unnecessarily extend the recording period, thereby using an excessive amount of storage space on the recording medium.

As another example of the difficulties for the viewer caused by the shear volume of available programming, the consumer must often record over previously recorded programming/content to subsequently record an event due to the limited storage space on the recording medium of the presently available personal video recorders. Once this situation arises, the previously recorded programming/content is expunged from the recording medium. When this previously recorded programming/content is a pay-per-view event, the subscriber is nonetheless charged the purchase fee for the recorded, yet unviewed, programming/content.

Since the presently available personal video recorders have only a single tuner, a further example of their shortcomings is that the buffer is cleared as the channel is changed, discarding the cached portion of the programming corresponding to the originally-viewed channel. Upon a return to the originally-viewed channel, the discarded programming is unavailable for viewing.

Consequently, there is a need in the art for a method and apparatus that ensures that the selected programming is recorded in its entirety despite schedule changes, program overruns and changing channels that may occur.

Moreover, there is an additional need in the art for a method and apparatus that ensures that the subscriber is not charged a purchase fee for a pay-per-view event that was purchased, but not viewed.

### SUMMARY OF THE INVENTION

It is an object of the present invention to meet the above-described needs and others. Specifically, it is an overall object of the present invention to provide a personal versatile recorder that provides the advantages of a personal versatile recorder while managing multimedia data in a wide variety of other possible file and streaming formats. Furthermore, it is an object of the present invention to provide a method and apparatus that alleviates caching and transmission difficulties currently experienced in webcasting streaming audiovisual signals.

Additional objects, advantages and novel features of the invention will be set forth in the description which follows or may be learned by those skilled in the art through reading these materials or practicing the invention. The objects and advantages of the invention may be achieved through the means recited in the attached claims.

To achieve these stated and other objects, the present invention may be embodied and described as a personal versatile recorder for recording any type of data. The personal versatile recorder of the present invention is preferably integrated with a set-top terminal to share a common central processing unit; associated firmware and software, decoding and security elements, interfaces, and the like, as well as a data storage device; a connection for receiving audiovisual programming; and for receiving one or more data transport streams. The same connection may serve both functions by receiving both audiovisual programming transport streams and at least one data transport stream, e.g. a cable television system interface.

In accordance with the present invention, content is recorded using a personal versatile recording apparatus. The personal versatile recording apparatus includes plurality of tuners, wherein the content is individually selectable by each tuner of the plurality of tuners. When a first tuner of the plurality of tuners is tuned to an original channel to select original channel content for viewing, the original channel is the viewed channel. The original channel content is cached while presenting the original channel content for viewing. A second tuner of the plurality of tuners may be tuned to at least one subsequent channel to select subsequent channel content for viewing while simultaneously caching the original channel content. By tuning the second tuner to the subsequent channel, the subsequent channel replaces the original channel as the viewed channel. However, the personal versatile recording apparatus continues caching the original channel content. When the original channel replaces the subsequent channel for viewing, the original channel becomes the viewed channel, and a user input permits the retrieval of the cached original channel content from cache for viewing. The personal versatile recording apparatus also generates a warning that the cache is about to become full become full to say to prompt user for action. The size of the cache is manually selectable.

The personal versatile recording apparatus may store the original channel content within cache while storing the subsequent channel content onto a recording medium to simultaneously record the original channel content and the subsequent channel content. This recording medium includes an internal disk located within the personal versatile recording apparatus.

The personal versatile recording apparatus may extemporaneously record the hindmost portion of the content presented on the viewed channel. This hindmost portion of the content is the last segment of the content to be presented for viewing. The portion of the content deemed to be the hindmost portion continually shifts as the content is streamed for presentation. To instantaneously record the hindmost portion, a time duration for recording the hindmost portion of the content is established. This time duration is the amount of record time that is allocated by the personal versatile recording apparatus to record the hindmost portion of the content. Establishing this time duration includes entering the time duration as a time default value, where it remains as the established time duration for recording the hindmost portion of the content. In addition, this time duration may be individually varied for each individual hindmost portion by entering a record time duration for each individual hindmost portion to be recorded or by marking the start and endpoint of the content to be recorded.

Using personal versatile recording apparatus to receive a telephony call, the viewed content that is stored within the cache is automatically transferred onto the recording medium when the cache becomes full. This allows the viewer to accept the call without missing the interrupted programming.

Upon reproduction or playback of the recorded content, a frame of the reproduced content may be selected for various types of graphical manipulation. This manipulation of the selected frame includes enlarging the selected frame, placing a border around a selected portion of the selected frame, and enlarging a portion of the selected frame enclosed by the border. The selected frame, either without manipulation or as manipulated, may be stored onto the recording medium.

The personal versatile recording apparatus permits the annotation of content and the recording of the annotated content onto a recording medium. Once annotated, the recorded content can then be referenced and managed. Management includes searching for the recorded content, finding the recorded content, replacing the recorded content, sorting the recorded content, and listing the recorded content.

As a security feature, the personal versatile recording apparatus is uniquely associated with its recording medium to prevent the unauthorized use of the recording medium by another personal versatile recording apparatus. This association also prevents the playback of content on the recording medium by another versatile recording apparatus. This unique association is established by associating the personal versatile recording apparatus with the recording medium, and generating a descriptor file containing at least one descriptor. The descriptor has a descriptor value that is unique to the versatile recorder apparatus and the recording medium. No other personal versatile recorder apparatus can generate the same descriptor value. For added security, the descriptor may be signed or encrypted using a unique encryption key contained within the personal versatile recording apparatus.

The descriptor is then stored within the protected memory of the versatile recorder apparatus and written onto the recording medium as a hidden file. Writing the descriptor file onto the recording medium is performed either when the recording medium is previously unrecorded as a result of authorized first time use and content is initially recorded onto the recording medium, or when content is recorded after repair of the recording medium. The hidden file is modifiable only by the versatile recorder apparatus that originally generated the descriptor file. A different personal versatile recording apparatus cannot modify the hidden file.

To compare the hidden file with the descriptor in memory, the hidden file is read from the recording medium and authenticated. Reading the hidden file from the recording medium is performed either under the direction of the personal versatile recorder apparatus or under the direction of the system operator. Authenticating the descriptor of the hidden file requires a match between the descriptor stored within the hidden file and the descriptor stored within the descriptor stored in memory. When the descriptor of the hidden file fails to match that stored within the personal versatile recorder apparatus, the recording medium is marked to identify this discrepancy between the hidden file and the descriptor file.

When the recording medium is used with a different personal versatile recorder apparatus, the hidden file must be removed from the recording medium to allow a new hidden file to be written to the recording medium. The new hidden file correlates the recording medium with the newly associated versatile recorder apparatus. Reasons for correlating the recording medium with another set-top terminal/personal versatile recorder unit include, but art not limited to, recycling/refurbishing the recording medium, recycling/refurbishing the personal versatile recorder apparatus, or legitimately reassigning the recording medium to another personal versatile recorder apparatus. If dissimilar information is contained hidden file and the descriptor file, the recording medium is marked and reported as suspect, and remedial action is commenced by the personal versatile recorder apparatus or the MSO using existing report back mechanisms. This discrepancy is reported back to the MSO to advise the system operator of this condition. Thus, the presence of the hidden file on the recording medium prevents the operation of the recording medium with another set-top terminal/personal versatile recorder unit, another set-top terminal, or another personal video recorder.

When an advertisement indicating that an event or program is to be presented on a specific channel at a scheduled time period, the personal versatile recording apparatus permits the automatic scheduling of the event or program for recording on the specific channel at the scheduled time period. This automatic scheduling is performed without a manual entry of specific channel at the scheduled time period. Instead, by having the user make a selection (either on the screen or the remote control) while the advertisement is being presented the personal versatile recording apparatus automatically schedules the event or program for recording.

These and other features are explained below.

### BRIEF DESCRIPTION OF THE DRAWINGS

The accompanying functional drawings illustrate the present invention and are a part of the specification. Together with the following description, the drawings demonstrate and explain the principles of the present invention.

FIG. 1 is a block diagram of a personal versatile recorder according to the present invention.

### DETAILED DESCRIPTION OF THE PREFERRED EMBODIMENTS

Using the drawings, the preferred embodiments of the present invention will now be explained. These functional embodiments are illustrative and chosen for exposition of the principles of the present invention. The invention is not, however, limited to the following embodiments, as will be appreciated by those skilled in the art.

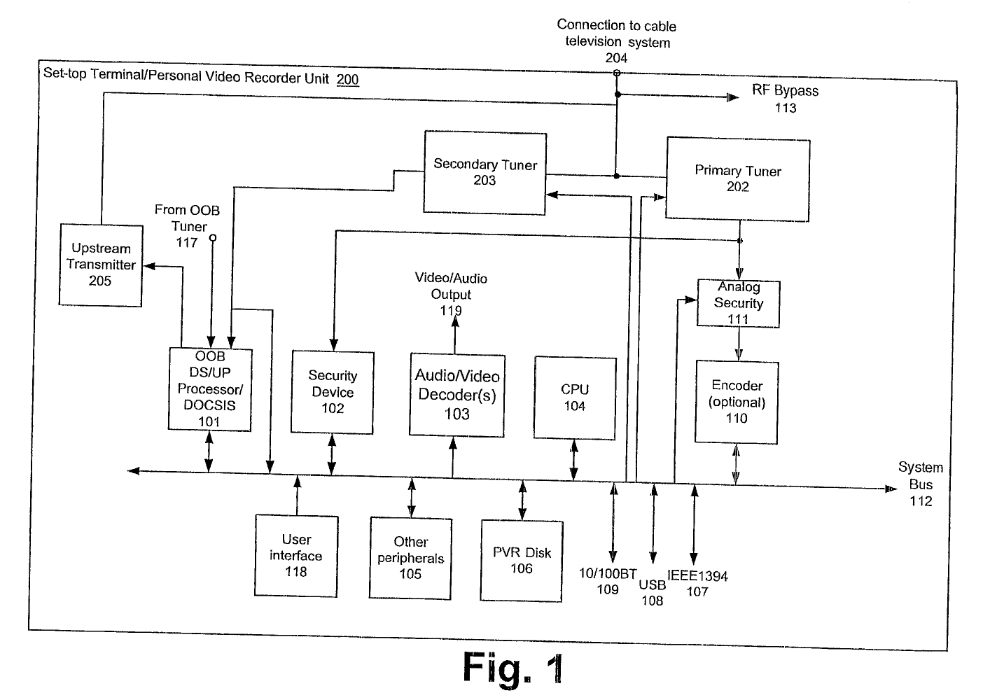

Depicted within FIG. 1 is the set-top terminal/personal versatile recorder unit (200) of the present invention. Incorporating a personal versatile recording device (PVR) integrated along with a set-top terminal, the set-top terminal/personal versatile recorder unit (200) performs all functions of a traditional set-top terminal while performing additional features that include, but are not limited to, recording, buffering, and retrieving multimedia content. Connected between or as part of a user's television set and cable box, satellite receiver or antenna, the personal versatile recorder controls the channel tuned on the television.

This multimedia content includes, but is not limited to, audiovisual programming such as compressed or pre-compressed programming. Audiovisual programming is not limited to a single video stream, e.g., a single camera angle, but can also include user-selectable multiple camera angles. Similarly for the audio, it may contain multiple audio streams that are user selectable. The audiovisual programming, such as a television broadcast, webcast programming or any streamed or non-streamed content, can be received by the set-top terminal/personal versatile recorder unit (200) either as an analog signal or as an MPEG-2 digital data stream, Internet Protocol, and the like. This multimedia content also includes video files, picture and graphics files, audio files, HTML files, text files, application software files, e-mail, universal resource locator (URL) links, and the like.

The set-top terminal/personal versatile recorder unit (200) also provides access to the Internet, and performs as a personal versatile recorder to record and playback any multimedia content.

A user interface (118) is incorporated within the set-top terminal/personal versatile recorder unit (200). The user interface (118) permits the user to control and interact with the set-top terminal/personal versatile recorder unit (200). The user interface (118) comprises any control devices with which the user inputs commands to the set-top terminal/personal versatile recorder unit (200) such as a keypad, a keyboard, a microphone, a trackball, a joystick, knobs, dials, switches, and the like. The user interface (118) inputs commands to application software executed by the central processing unit (104). This software provides display menus that are navigated using a remote control unit (not shown). This remote control unit, which is an integral part of the user interface (118), wirelessly transmits commands to the set-top terminal/personal versatile recorder unit (200).

The user interface (118) also permits the entry of commands to the corresponding applications that are executing on the central processing unit (104) to perform the features that include, but are not limited to, the recording of multimedia content, the selection of content to be downloaded from the Internet, and the selection of other operations or setting other parameters associated with an agent application.

The user interface (118) permits the annotation of any multimedia content recorded by the set-top terminal/personal versatile recorder unit (200) to allow the access to and manipulation of the recorded multimedia content. To annotate the recorded content, a string of characters is displayed on a display device. This character string is generally a descriptive character string. Using this annotation permits the set-top terminal/personal versatile recorder unit (200) to search, find, replace, sort, and list the recorded multimedia content. This annotation feature works in conjunction with the file system for the set-top terminal/personal versatile recorder unit (200). By storing the content as a file, this file system references and manages the recorded content in a manner similar to file systems of a personal computer.

The set-top terminal/personal versatile recorder unit (200) includes the personal versatile recorder disk (106) as a hard disk drive. Having the hard disk drive internal to the recorder, the set-top terminal/personal versatile recorder unit (200) supplants the video cassette as a content recording medium. The personal versatile recorder disk (106), connected to the system bus (112), provides a mass data storage medium on which the central processing unit (104) caches or records any type of multimedia content. The personal versatile recorder disk (106) includes a hard drive, magnetic disk, optical disk, magneto-optical disk or the like. If the audiovisual data is streamed, e.g. webcast, data could be written onto the personal versatile recorder disk (106) for caching purposes (subsequent use by the application software on a dynamic basis) or could be permanently stored.

The set-top terminal/personal versatile recorder unit (200) of the present invention is also used to perform a caching function that decreases the bandwidth demands placed on the connected network and enhances data retrieval rates. For example, some web sites, content, and the like, could include audiovisual elements that are always constant. Therefore, rather than downloading these elements each time that web site or the content is accessed, those constant elements are recorded, or cached on the personal versatile recorder disk (106) of the recorder and retrieved from there. This decreases the bandwidth demand on the network and decreases the time required to provide the display desired by the user.

Multimedia content that is transmitted as digital data from the MSO to the set0top terminal/personal versatile recorder unit (200) is transmitted using Quadrature Amplitude Modulation (QAM). Using QAM, digital data bit streams are modulated onto a radio frequency (RF) carrier signal in mode such that the value of each data bit is ascertained based on the phase and amplitude of the RF carrier signal. The QAM RF carrier signal is then demodulated to recover the transmitted data using the primary tuner (202) or the secondary tuner (203), which are both in-band tuners, or the OOB data tuner (117), which is an out of band tuner.

Digital data, multimedia files and application software, are also transmitted to the set-top terminal/personal versatile recorder unit (200) over the cable television system on an out-of-band (OOB) control channel to the OOB data tuner (117). Although for bandwidth capacity considerations, the in-band (primary tuner) or the secondary in-band tuner is more suitable. An OOB data channel is utilized primarily to facilitate conditional access functions for traditional and emerging services offered by the system operator as described in the prior art.

As shown in FIG. 1, the set-top terminal/personal versatile recorder (200) of the present invention also includes a primary tuner (202). The primary tuner (202) is preferably a broadband tuner that is used to tune a particular program offered over one of the hundreds of channels available from the cable system. The multimedia content received through the primary tuner (202) is buffered and selectively recorded on the personal versatile recorder disk (106) under the control of the central processing unit (104). Additionally, other data may be embedded within the television signal received through the primary tuner (202).

The secondary tuner (203) is used mainly to tune to the data transport stream within the signal from the cable television system (204) to free the primary tuner (202) for more conventional tuning of a television channel that the user desires to receive. This secondary tuner (203) may operate in accordance with any multiple access modems that facilitate bi-directional communication between the set-top terminal/personal versatile recorder unit (200) and the headend (not shown). The Data Over Cable Service Interface Specification (DOCSIS) standard is used to facilitate Internet access in cable systems. The data transport stream from the DOCSIS tuner (203) is provided to a DOCSIS modem (101). The connection to the DOCSIS tuner (203) allows the central processing unit (104) to control which data stream is provided to the DOCSIS modem (101) in cases where there are multiple data transport streams comprised within the signal from the MSO.

The DOCSIS modem (101) communicates with the central processing unit (104) over the system bus (112), and incorporates an upstream processor that drives the transmitter (205) to facilitate upstream DOCSIS transmission as well as to support existing report-back protocols (101) used to manage the cable television system. Additionally, for bi-directional communication, an upstream transmitter (205) is provided in connection with the DOCSIS modem (101). The DOCSIS modem (101) thus provides bi-directional communication for Internet access, user requests of web pages, files, session requests, purchase requests, and the like.

One of the many functions of the set-top terminal/personal versatile recorder unit (200) is providing, to the viewer, recording and retrieval capabilities for the playback or examination of programming or multimedia content. The set-top terminal/personal versatile recorder unit (200) buffers and caches incoming audiovisual programming so that the viewer can fast forward or pause a live television program or replay a portion of a live television program without missing any subsequent segment of the program. This feature is available with the set-top terminal/personal versatile recorder unit (200) as long as the duration of programming to be captured during the fast forward, pause or replay does not exceed the capacity of the recording medium. Similarly, the viewer can choose to record an entire program after watching it for some time, so long as the recording is started and completed before the capacity of the recording medium is exceeded.

An additional purpose of the secondary tuner (203) is to optionally allow for the respective recording and viewing of separate audiovisual programming offered at two distinct frequencies, i.e., on different channels, or from different sources such as streamed audiovisual content from the Internet and broadcast television programming. The viewer can control the channel tuned on the television to browse a succession of channels, also known as channel-surfing. The secondary tuner (203) is used in conjunction with the primary tuner (202) to simultaneously view two different television channels or audiovisual data streams, to view a second channel or audiovisual data stream, or to “channel-surf” while concurrently recording content on an original channel selected by the primary tuner (202).

Using multiple tuners, the content recorded by the set-top terminal/personal versatile recorder unit (200) is uninterrupted when the viewed channel is changed. Specifically, as the viewed channel is changed to a subsequent channel, the secondary tuner (203) is then tuned to the subsequent channel, while the primary tuner (202) remains tuned to the original channel. The set-top terminal/personal versatile recorder unit (200) presents the secondary channel content for viewing while continuing to cache the original channel content onto the personal versatile recorder (PVR) disk (106). Optionally, a warning prompt is generated for viewing to indicate that the cache is about to become fall. In either case, the size of the cache for recording may be selectable through the user interface (118). Upon returning to the original channel, the original channel content is accessed from the cache and presented for viewing. The user interface (118) permits the entry of a command to accessed the original channel content from the cache either from the time when the viewed channel had been changed to the subsequent channel, or alternatively, from the time prior to when the viewed channel had been changed. If the subsequent channel prevails as the viewed channel, the user interface (118) also permits the entry of a command to activate the “watch & record” feature of the set-top terminal/personal versatile recorder (200) to record (not only cache) the content of the original channel onto the personal versatile recorder disk (106). If the subsequent channel supplants the original channel as the channel to be cached, the primary tuner (202) is tuned to the subsequent channel, the subsequent channel content is then cached onto the personal versatile recorder disk (106), and the subsequent channel then becomes the above-identified original channel.

When the set-top terminal/personal versatile recorder unit (200) receives either a voice telephony call or a video telephony call, the set-top terminal/personal versatile recorder unit (200) automatically transfers the viewed content stored within the cache to the personal versatile recorder disk (106) once the cache becomes full. Transferring the viewed content in this manner allows the viewer to accept the telephony call without missing the interrupted programming. As a result of this transfer feature, none of the viewed content is lost while the viewer is engaged in a telephony call.

The multiple tuners within the set-top terminal/personal versatile recorder unit (200) permit the simultaneous recording of more than one audiovisual programming content stream. In particular, the user interface (118) permits the entry of a command to activate this simultaneous recording option. When this feature is activated, a content stream that is selected by one of the multiple tuners is stored within cache while another content stream that is selected by another of the multiple tuners is simultaneously stored onto the personal versatile recorder disk (106).

Upon reproduction (playback) of the audiovisual content recorded onto the personal versatile recorder disk (106), or when the cached channel content is retrieved from cache, the user interface (118) permits the selection of a specific frame for various types of graphical manipulation. This manipulation includes, for example, a zoom feature to enlarge the frame, a border feature to place a border around a selected portion of the frame, and a crop feature to enlarge only the portion of the frame enclosed by the border. The cropped segment may be saved before or after graphical manipulation. Storage of the manipulated frame onto the personal versatile recorder disk (106) is also permitted.

Control lines to the primary tuner (202) and the secondary DOCSIS tuner (203) are provided from the system bus (112). This allows the user to input tuning commands to the system using the user interface (118) so as to control the channel tuned by the primary tuner (202). Consequently, the two-tuner configuration allows for, inter alia, the following operating modes of interest:

a) watching an analog channel, recording a digital program (encrypted or in the clear);

b) watching a clear digital program and recording a digital program (encrypted or in the clear);

c) watching an encrypted program and recording an analog channel or a second digital program in the clear; and

d) watching picture-in-picture, where the first signal is received from the primary tuner while the second is played back or retrieved from the personal versatile recorder disk (106).

For cases a through d, as set forth hereinabove, involving an encrypted (enciphered) MPEG-2 stream, the stream goes through the security device (102) for decryption (deciphering). Such decryption is achieved within the set-top terminal/personal versatile recorder unit (200) using the Data Encryption Standard (DES) algorithm. DES is Federal Information Processing Standard (FIPS) cryptographic algorithm that includes a bit key having a length of, for example, 56-bits. Using this algorithm, encrypted data passing through the security device (102) are decrypted to be converted into its unencrypted form. When the decrypted signal is to be watched (instead of being recorded), it is processed by the decoder (103). As shown in FIG. 1, the decoder (103) comprises a single decoder or a series of decoders.

When the television signal for that channel is an analog signal, it is then transmitted to the system bus (112) through an analog security circuit (111) for descrambling the signal when the signal is scrambled, and through an optional encoder (110) for hardware assisted compression. If the set-top terminal/personal versatile recorder unit (200) is intended to process and record only digital programming, as analog transmission is phased out, the analog security (111) and the encoder (110) as illustrated are no longer necessary. Nevertheless, the encoder (110) may be retained for encoding other analog signals from alternate analog input sources for other applications.

As another security feature, the content of the personal versatile recorder disk (106) is encrypted and the interface between the set-top terminal/personal versatile recorder unit (200) and the personal versatile recorder disk (106) is mechanically tamper resistant to prevent the unauthorized removal of the personal versatile recorder disk (106).

As an additional security feature, the set-top terminal/personal versatile recorder unit (200) is uniquely associated with its internal personal versatile recorder disk (106). This unique association prevents the unauthorized use of the personal versatile recorder disk (106) by another set-top terminal or personal versatile recorder unit, and also prevents the playback of content on the personal versatile recorder disk (106) by another set-top terminal or personal versatile recorder unit other than the associated set-top terminal/personal versatile recorder unit (200). This unique association is established as follows.

Prior to the time that content is initially recorded onto the personal versatile recorder disk (106), the set-top terminal/personal versatile recorder unit (200) generates a descriptor file containing a particular descriptor or a particular plurality of descriptors. The descriptor is a data word having a variable bit length. This descriptor or this plurality of descriptors, having a unique descriptor value, may be unencrypted. For additional security, the descriptor may be encrypted using the encryption key contained within the set-top terminal/personal versatile recorder unit (200) or it may be a digital signature. The descriptor value is unique to the set-top terminal/personal versatile recorder unit (200) and its associated personal versatile recorder disk (106). This descriptor is stored for future reference within protected memory contained within the set-top terminal/personal versatile recorder unit (200). When a digital signature is used for descriptor authentication the descriptor is signed prior to its storage with the protected memory. No other set-top terminal or personal versatile recorder unit can generate that same descriptor value or signature.

When content is initially recorded onto the previously-unrecorded personal versatile recorder disk (106) as a result of authorized first time use, or when content is recorded after repair of the versatile recorder disk (106), the descriptor file is written onto the personal versatile recorder disk (106) as a hidden file. Writing the descriptor file is performed using a process that prevents the transfer descriptor data to a device other than the personal versatile recorder disk (106). The hidden file is modifiable by the set-top terminal/personal versatile recorder unit (200) that originally generated the descriptor file, alone. A different set-top terminal or a different personal versatile recorder unit cannot modify the hidden file. Moreover, when the personal versatile recorder disk (106) is to be used with another set-top terminal/personal versatile recorder unit, the existing hidden file must be removed from the personal versatile recorder disk (106) for the purpose of writing a new hidden file onto the personal versatile recorder disk (106). Reasons for associating the personal versatile recorder disk (106) with another set-top terminal/personal versatile recorder unit include, but art not limited to, recycling/refurbishing the personal versatile recorder disk (106), recycling/refurbishing the set-top terminal/personal versatile recorder unit (200), or legitimately reassigning the personal versatile recorder disk (106) to the other set-top terminal/personal versatile recorder unit. The removal of the existing hidden and the writing of the new hidden file onto the personal versatile recorder disk (106) is necessary for associating the other set-top terminal/personal versatile recorder unit with the personal versatile recorder disk (106).

A program application within the set-top terminal/personal versatile recorder unit (200) or a command from the MSO directs the set-top terminal/personal versatile recorder unit (200) to read the hidden file previously recorded on the personal versatile recorder disk (106). Once read from the personal versatile recorder disk (106), the hidden file is compared with the descriptor stored within the protected memory of the set-top terminal/personal versatile recorder unit (200). The set-top terminal/personal versatile recorder unit (200) authenticates as valid only the signature and the descriptor or descriptors stored within the hidden file of the versatile recorder disk (106) that match those stored within the protected memory of the set-top terminal/personal versatile recorder unit (200). When dissimilar information is contained hidden file and the descriptor file, the personal versatile recorder disk (106) is marked and reported as suspect, and remedial action is commenced by the set-top terminal/personal versatile recorder unit (200) or the MSO using existing report back mechanisms. This discrepancy is reported back to the MSO to advise the system operator of this condition. Thus, the presence of the hidden file on the personal versatile recorder disk (106) prevents the operation of the disk (106) with another set-top terminal/personal versatile recorder unit, another set-top terminal, or another personal video recorder.

Within the audio/video decoder (103), the content is decoded, converted to an analog signal, and then provided to the video/audio output (119). For example, when the decrypted content is to be viewed instead of being recorded, it is processed by the audio/video decoder (103). Additionally, the audiovisual signal recorded on the personal versatile recorder disk (106) is retrieved and processed through the audio/video decoder (103) and then provided to the video/audio outputs (119) of the set-top terminal/personal versatile recorder unit (200).

Another function performed by the personal versatile recorder of the present invention is called transcoding. The data must be decompressed for optimal display and compressed for storage on the disk (106). This compression and decompression of multimedia data is performed by the central processing unit (104) and is known as transcoding. Transcoding is either performed in real-time so that MPEG-2 or streamed audiovisual programming is displayed or stored for offline transcoding. If transcoding is performed offline, the compression rate of the compressed stream is varied as desired by the user to tradeoff amount of storage space required by the compressed signal versus signal quality. The user controls the transcoding performed by the recorder through the user interface (118).

Interfaced with a system bus (112), the central processing unit (104), with associated firmware and software, executes software necessary to extract, display and record multimedia content to the personal versatile recorder disk (106). The central processing unit (104) activates or executes browser software at the user's request to display the HTML file on the screen of television set when an HTML file is stored on the personal versatile recorder disk (106). When the file contains additional URLs that the user wishes to examine, then the application uses the DOCSIS path to contact the corresponding server.

When an image file is stored on the personal versatile recorder disk (106) or received through the DOCSIS modem (101), the central processing unit (104) executes image manipulation software with which the image file is displayed on the television set.

The application software necessary to retrieve or “play” the multimedia files on the personal versatile recorder disk (106) is also stored on the personal versatile recorder disk (106) for use by the central processing unit (104). When a video or an audio file is stored on the personal versatile recorder disk (106) or received through the DOCSIS modem (101), the central processing unit (104) executes the player program software application to provide video and/or audio signals to the television set connected to the video/audio outputs (119).

The smart agent is a software application, also executed by the central processing unit (104), that automatically tunes, records, acquires or caches the multimedia content for later review by the user as specified by parameters input by the user. This software application has pre-established content rights management capabilities incorporated therein. Content rights management capabilities, include but are not limited to, those provided under the framework of the Secure Digital Music Initiative (SDMI) (incorporated herein by reference), and the like. The SDMI standards include a framework to guide content management implementation in personal electronic devices, music-playing software and digital music recordings to prevent or limit a user's ability to make unlawful copies of that copyrighted multimedia content. When the necessary or desired application software, along with associated content rights management, is not provided on the personal versatile recorder disk (106), the necessary or desired application software is also downloaded through either of the primary and secondary tuners (202, 203), and then stored on the personal versatile recorder disk (106) or in memory (not shown).

The set-top terminal/personal versatile recorder unit (200), when coupled with content management software, provides a basis for a recorded content storage library by incorporating corresponding capabilities such as categorization and search functions. The smart agent application software is also used to develop a set of user profiles. When the smart agent application software contains contents rights management capability, content conforming to these developed profiles is selectively recorded onto the Personal versatile recorder disk (106), or onto a similar recording medium, depending on what access rights the user has for this content. Custom compact disks are recorded when a recordable or rewritable compact disk, instead of the personal versatile recorder disk (106), is used as the storage medium. This concept equally applies to storage devices and media other than the compact disk. For example, a compact flash device, or other recordable medium are used instead of a compact disk.

In addition to recording music conforming to developed profiles, the present invention also includes the ability to identify and “tag” a song that is in progress for recording at a later time. These recording features, which honor content rights management, facilitate consumer convenience and generate an additional source of revenue to the MSO and/or the music studios and artists.

The set-top terminal/personal versatile recorder unit (200) also provides an on-screen listing of all content provided by the MSO. This listing is known in the art as an interactive electronic programming guide (EPG). Certain implementations of the EPG allow the user to view a given channel while browsing the EPG in a portion of the television screen without changing channels.

The smart agent application also monitors the EPG for television programming of interest to the user based on user-input parameters. These user-input parameters may include channel type, program name, genre, or any user defined string of characters. The smart agent application also ensures that the selected programming is recorded in its entirety despite schedule changes and overruns that may occur.

Additionally, the smart agent application provides the recording flexibility to accommodate programming that extends beyond a given time period, thus, greatly enhancing the accuracy and the granularity of the recording period for programs with unpredictable start/end times. As a result, the duration of live events is determined with a small margin of error, and without using an excessive amount of storage space on the recording medium. This flexibility is accomplished by receiving a broadcast message from a designated event scheduler that provides programming schedules, such as an electronic programming guide (EPG) server (not shown), to inform the set-top terminal/personal versatile recorder unit (200) when to halt the recording procedure.

Pursuant to this approach, the consumer programs the set-top terminal/personal versatile recorder unit (200) to record the desired event, using the user interface (118). The set-top terminal/personal versatile recorder unit (200) registers with the electronic programming guide server so that the set-top terminal/personal versatile recorder unit (200) is notified by the electronic programming guide server when the event has actually ended. When the event has ended, the electronic programming guide server sends at least one multicast message to the set-top terminal/personal versatile recorder unit (200) to notify the registered set-top terminal/personal versatile recorder unit (200) that the event has actually ended. In lieu of sending at least one multicast message, the electronic programming guide server may broadcast the event end time regardless of the event time that has been previously programmed into the set-top terminal/personal versatile recorder unit (200). The broadcast approach eliminates the need for the set-top terminal/personal versatile recorder unit (200) to register because the message is sent to the set-top terminal/personal versatile recorder unit (200) on the network, hence, the network traffic is considerably reduced.

Alternatively, this recording flexibility is accomplished by continually updating, in near-real-time, the data produced by the electronic programming guide server. This data is then used by the set-top terminal/personal versatile recorder unit (200) to determine the appropriate start and end times for the desired programs. Pursuant to this approach, the consumer programs the set-top terminal/personal versatile recorder unit (200) to record the desired event, using the user interface (118). The smart agent application software continuously monitors data from the electronic programming guide server for any new or changed data; new or changed data from the electronic programming guide server is prioritized for network delivery. The smart agent application also controls the recording of this event onto the personal versatile recorder disk (106) for subsequent review by the consumer. As a result, recording of the desired event onto the personal versatile recorder disk (106) is initiated and halted by the agent application based on the most current information from the electronic programming guide server. In addition, according to this alternative embodiment, the agent application may control the recording of the event by beginning the recording procedure at a first time that is immediately before the starting time of that event and ending the recording procedure at a second time that is immediately after the completion time of that event, the first time and the second time being determined in near-real-time by the updated data produced by the electronic programming guide server. Moreover, according to this alternative embodiment, the agent application may control the duration of the event after the event has been recorded. In particular, a short time after recording the event, the agent application may use the updated, near-real-time data produced by the electronic programming guide server to accurately establish the times when the event has started and ended. By accurately establishing these times, the portion of the event that has been recorded before the event has started and after the event has ended is then deleted from the recording. This procedure is applicable to the recording of an event having a “modified” start time (e.g., for programs that are preceded by promotional segments as currently produced by Public Television stations). Furthermore, this procedure offers two benefits to the consumer in that it provides a clean recording (the consumer gets exactly the program they want with nothing more) and it frees up the disk space used by the excess recording time, making room for additional recording capacity on the personal versatile recorder disk (106).

The user interface (118) additionally permits a single user entry to activate an impromptu recording option. Using this impromptu recording option, the hindmost portion of the content in the cache is instantaneously recorded on the personal versatile recorder disk (106) at the direction of the viewer. This hindmost portion of the content is the last segment of the content to be presented for viewing. The portion of the content deemed to be the hindmost portion continually shifts as the content is streamed for presentation. The record time duration of this hindmost portion is also established as a user interface (118) command entry. This time duration is the amount of record time that is allocated by the personal versatile recording apparatus to record the hindmost portion of the content. The time duration for the record time duration, persisting from seconds to minutes, is entered as a time default value using the user interface (118), where it remains as the established time duration. In addition, the time duration for each hindmost portion to be recorded may be individually varied for each individual hindmost portion through the user interface (118). To vary the record time duration for an individual hindmost portion the record time duration for each individual hindmost portion to be recorded is entered or the starting point and endpoint of the content to be recorded are marked as an alternative to entering the record time duration.

Recording flexibility is accomplished by tagging the program stream corresponding to a given program with program start indication and a program end indication. This is done in a number of ways. First, tagging of live events may require manual oversight at the source the program stream. Alternatively, the implementation, the beginning and the end of the program are indicated in a descriptor placed in a program map table (PMT). As another option, a descriptor is placed as a separate message indicating the beginning and the end of the program.

Another feature of the set-top terminal/personal versatile recorder unit (200) permits the automatic scheduling of a future event for recording at the time and on the channel designated in the advertisement without the manual entry of the designated time or channel. Instead, scheduling of a future event automatic occurs automatically while the advertisement is being displayed. A future event includes programming content to be shown in the future on the same channel or on a different channel. The event may represent programming content that is to be presented only on one occasion, such as a one-time program, such as a movie, or a single episode of a program series. The event may also represent a collection of related content, such as a compilation of works or episodes, or a program series.

While the advertisement for the future event is being displayed and the viewer desires to record the event being advertised, the viewer makes an entry through the user interface (118) using either the remote control unit or the EPG/smart agent interface screen. This entry by the viewer permits the set-top terminal/personal versatile recorder unit (200) to automatically schedule, for recording, content to be presented only on one occasion or a number of consecutive occasions in a series scenario.

Upon activation of this automatic scheduling feature, a database that contains the time of the advertisement and the advertised program is then accessed by the EPG or smart agent to associate the time of the advertisement with the program is being advertised. This association, along with the establishment of the recording time, is achieved either by the EPG using data entered into the EPG system, or by the smart agent using the data entered into the EPG system. Alternatively, this association and establishment of the recording time is achieved by the access of either the EPG or the smart agent application to a digital stream contained within the advertisement for the purpose of associating the time of the advertisement with the program is being advertised. This digital stream includes meta-data that associates the advertisement with the program and associated schedule as advertised. A standard used to format this meta-data may include, the Advanced Television Enhancement Forum (ATVEF) standard or any other standard that allows the smart agent to access and process this data.

Through this association of the advertisement with the event being advertised, the smart agent schedules the future event for recording by programming the set-top terminal/personal versatile recorder unit (200) to record the event at the time and on the channel designated in the advertisement. This programming includes establishing the channel designated in the advertisement as a record channel, establishing the advertised time as a record time, and establishing the advertised date as a record date.

When the advertised programming content is content to be presented only on one occasion and that content is selected for recording, the set-top terminal/personal versatile recorder unit (200) automatically schedules that content for recording by programming the set-top terminal/personal versatile recorder unit (200) to record that content at the time and on the channel designated in the advertisement. However, when the advertisement suggests that the advertised programming content is part of a collection of related content and that collection is selected for recording, the set-top terminal/personal versatile recorder unit (200) automatically schedules that collection for recording by programming the set-top terminal/personal versatile recorder unit (200) to separately and individually record each of the works or episodes at there respective time and on there respective channel. This automatic process takes place unless the user has selected, a priori, a configuration option that presents the user a query that allows the user to decide whether to record only the upcoming advertised event one time or the series of events.

Automatic scheduling is performed without a manual entry of specific channel at the scheduled time period, or without the manual entry of a specific code representing the event to be recorded. Instead, by entering a command while the advertisement is being presented the personal versatile recording apparatus automatically schedules the event or program for recording. On the record date and at the record time, the set-top terminal/personal versatile recorder unit (200) is automatically tuned to the record channel and the recording of the event commences as scheduled.

Another feature of the set-top terminal/personal versatile recorder unit (200) of the present invention provides the MSO the choice of offering multimedia content in accordance with user preferences and/or user demographics. The content is delivered to one or a group of set-top terminal/personal versatile recorder units (200) in an encrypted format having particular demographics and/or preference criteria at certain timeframes or when requested by a given user. For example, the MSO advertises that a program or movie is offered for viewing for a specific duration, a day, a week, and the like. The viewer selects the download option, which is then performed as a background procedure when the content becomes available for viewing after a specified timeframe. This option is offered to the user as content that is purchasable “on demand”.

The set-top terminal/personal versatile recorder unit (200) provides for the storage of multimedia content in an unencrypted format. But when content that has been stored in an encrypted format is selected for access, viewing or playback, it is accessed, viewed or played after it has been decrypted; but while it is stored on the personal versatile recorder disk (106), it remains encrypted. This also allows the user to have full motion control of the content itself as in a video-on-demand application but without having to use complex video servers at the headend or tying up network capacity for the duration of the program. Instead the network capacity used is only during the download of the content.

For multimedia content in the form of a pay-per-view event, the set-top terminal/personal versatile recorder unit (200) provides the option of applying a purchase fee for the pay-per-view event at a time other than when the order is placed. An option for selecting the assessment of the purchase fee includes charging the pay-per-view purchase fee when the event has been accessed, or played back from the personal versatile recorder disk (106). In charging a purchase fee when the pay-per-view content is accessed or played back from the personal versatile recorder disk (106), the set-top terminal/personal versatile recorder unit (200) performs in the following manner.

Initially, the pay-per-view content is transferred to the set-top terminal/personal versatile recorder unit (200) as a compressed digital data bit stream. The digital data bit stream is compressed using a compression technique such as an MPEG video compression technique, and the like. When this compressed digital data bit stream is transferred as encrypted, modulated data, such as when the compressed digital data bit stream is transferred directly from a multiple-channel programming network, the encrypted, modulated, compressed data bit stream is demodulated and decrypted by the set-top terminal/personal versatile recorder unit (200) to produce a compressed data bit stream. The compressed data bit stream is then decoded to convert the compressed data bit stream into an analog audiovisual signal.

As an additional feature of the present invention, when transcoding is desired in order to change the compression rate, signal format and/or resolution, an analog-to-digital conversion is performed to the analog audiovisual signal for re-encoding the analog audiovisual signal into a re-compressed data bit stream. The re-compressed data bit stream is then transcoded to the desired compression rate, signal format and/or resolution. This re-compressed, transcoded, data bit stream is then stored onto the personal versatile recorder disk (106).

As another feature of the present invention, the re-compressed, transcoded data bit stream is re-encrypted prior to storage onto the personal versatile recorder disk (106). The re-encryption is performed either using software or using hardware incorporated within the set-top terminal/personal versatile recorder unit (200), to produce a re-compressed, transcoded, re-encrypted data bit stream. The re-encryption scheme need not be identical to the original encryption scheme of the demodulated signal. The re-compressed, transcoded, re-encrypted data bit stream is then stored onto the personal versatile recorder disk (106).

As an alternative feature of the present invention, transcoding may be performed without the intermediate step of converting the compressed data bit stream into an analog audiovisual signal.

As an alternate feature of the present invention, when transcoding is not required, the encrypted, compressed data bit stream may remain encrypted or may be decrypted and re-encrypted for copy protection. The compressed digital bit stream is transferred onto the personal versatile recorder disk (106) for storage prior to decryption or decompression, and prior to conversion into an analog audiovisual signal.

The stored data bit stream is read from the personal versatile recorder disk (106), decrypted when stored as encrypted data, and decoded for viewing. Once the stored data bit stream is read, decrypted and decoded, the purchase event is registered as viewed by reporting the event back to a billing controller (not shown) and the purchase fee is applied.

As another alternate feature of the present invention, a preview time period authorization is contained within a message that is sent from the headend to the set-top terminal/personal versatile recorder unit (200). This preview time period authorization permits the viewing of the pay-per-view event without charge during the preview time period. Once the preview time period has lapsed, the purchase event is registered as a viewing by reporting the event back to the billing controller and the purchase fee is applied.

Since the pay-per-view event is likely to be copyright-protected content, the set-top terminal/personal versatile recorder unit (200) performs an inquiry to determine the existence of the requisite permission needed to maintain the content on the personal versatile recorder disk (106). When the permission to maintain the content on the personal versatile recorder disk (106) exists, the stored data bit stream remains on the personal versatile recorder disk (106) after it has been viewed until the time that the stored data bit stream is subsequently overwritten with another data bit stream or deleted. Conversely, when the permission to maintain the content on the personal versatile recorder disk (106) does not exist, the stored data bit stream is deleted from the personal versatile recorder disk (106) after it has been viewed.

The set-top terminal/personal versatile recorder unit (200) additionally permits the user to select the fee structure for the registration and assessment of the purchase fee. The fee structure includes the registration and assessment of the purchase fee when the event has been viewed. The fee structure also includes the registration and assessment of a partial charge upon recording the pay-per-view event and another partial charge upon when viewing the event, with the sum total of the partial charges equaling the purchase fee.

Another advantage of the set-top terminal/personal versatile recorder unit (200) is its utility in storing network-monitoring parameters and signal quality parameters in real time for later retrieval. Embedded or network-based trend analysis software is used to predict or detect network performance and/or degradation with greater granularity, such as the prediction or detection per residence or per device within a residence.

The set-top terminal/personal versatile recorder unit (200) of the present invention can be incorporated into a wireless home network. In accordance with this feature, the set-top terminal/personal versatile recorder unit (200) wirelessly shares content and services with peripheral devices that are located throughout the home. For example, through this wireless home network, music that has been previously recorded based on a user profile or music from a music service such as Music Choice®, or other content, is transmitted to an addressable wireless headphone or an addressable system component over the wireless networking link. This wireless home networking feature is not limited to the transmission of music.

To interface the set-top terminal/personal versatile recorder unit (200) of the present invention with other devices and systems, a number of additional interfaces are provided. For example, to interface a digital camera for multimedia mail applications, an IEEE1394 digital bus (107) or a Universal Serial Bus (USB) (108) are utilized. To transfer the files to a personal computer, or 10/100BT BaseT ethernet data interface (109), can be used. Also shown are connections to other peripheral devices (105). Through the connections (105), the IEEE1394 digital bus (107), the Universal Serial Bus (USB) (108), or the 10/100BT interface (109), the set-top terminal/personal versatile recorder unit (200) may record from another peripheral device such as an FM tuner, a compact disk (CD) player, a digital versatile disk (DVD) player, an MPEG Layer 3 (MP3) player, and the like. The prerequisites are a digitized stream with a networked access between the personal versatile recorder and these peripheral devices.

The user's television set (not shown) is connected to the video/audio outputs (119) thereby allowing the user to watch the selected programming. Furthermore, an RF bypass (113) allows direct signal routing to the connected display device. This display device includes, but is not limited to a monitor and a television set. The RF bypass (113) also allows direct signal routing to another device that includes a video cassette recorder, and the like.

The preceding description has been presented only to illustrate and describe the invention. It is not intended to be exhaustive or to limit the invention to any precise form disclosed. Many modifications and variations are possible in light of the above teaching.

The preceding description is intended to enable others skilled in the art to best utilize the invention in various embodiments and with various modifications as is suited to the particular use contemplated. It is intended that the scope of the invention be defined by the following claims.

What is claimed is:

1. A method for recording content using a personal versatile recording apparatus, said personal versatile recording apparatus having a plurality of tuners, wherein recordable content is individually selectable by each tuner of said plurality of tuners, the method comprising:
tuning a first tuner of said plurality of tuners to an original channel to select original
channel content for viewing, the original channel being a viewed channel; and caching said original channel content to a cache while presenting said original channel content for viewing.

2. The method of claim 1 further comprising:
tuning a second tuner of said plurality of tuners to at least one subsequent channel to select subsequent channel content for viewing while simultaneously performing said caching step, said subsequent channel replacing said original channel as said viewed channel.

3. The method of claim 2 further comprising:
recording said cached original channel content onto a recording medium.

4. The method of claim 2 further comprising:
tuning said first tuner to said subsequent channel; and
caching said subsequent channel content to said cache while presenting said subsequent channel content for viewing, said subsequent channel becoming said original channel.

5. The method of claim 2 further comprising:
replacing subsequent channel with said original channel as said viewed channel;
retrieving said cached original channel content from said cache; and
presenting said retrieved original channel content for viewing.

6. The method of claim 5, wherein said retrieved original channel content is said original channel content beginning from the time period when said subsequent channel replaced said original channel as said viewed channel.

7. The method of claim 5, wherein said retrieved original channel content is said original channel content beginning from the time period prior to when said subsequent channel replaced said original channel as said viewed channel.

8. The method of claim 1 further comprising:
tuning a second tuner of said plurality of tuners to at least one subsequent channel to select subsequent channel content; and
storing said original channel content within said cache while storing said subsequent channel content onto a recording medium to simultaneously record said original channel content and said subsequent channel content.

9. The method of claim 1 further comprising:
generating a warning that said cache is about to become full.

10. The method of claim 1 further comprising:
manually selecting, the size of said cache.

11. The method of claim 1 further comprising:
using personal versatile recording apparatus to receive a telephony call; and
transferring the viewed content stored within the cache onto a recording medium when said cache becomes full.

12. The method of claim 11, wherein said telephony call is a voice telephony call.

13. The method of claim 11, wherein said telephony call is a video telephony call.

14. The method of claim 1 further comprising:
annotating said original channel content; and
recording said annotated original channel content on a recording medium.

15. The method of claim 14 further comprising managing said recorded original channel content, said step of managing includes one of:
searching for said recorded original channel content,
finding said recorded original channel content,
replacing said recorded original channel content,
sorting said recorded original channel content, and
listing said recorded original channel content.

16. The method of claim 1 wherein an electronic programming guide searches said original channel content using one of, a channel name, a parameter specified by the user and an annotation contained within said original channel content.

17. The method of claim 1 wherein a smart agent searches said original channel content using one of, a channel name, a parameter specified by the user and an annotation descriptive of said original channel content.

18. The method of claim 1 further comprising:
selecting a frame of said cached original channel content for graphical manipulation; and
graphically manipulating said selected frame.

19. The method of claim 18 further comprising:
recording said selected frame onto a recording medium.

20. The method of claim 18 further comprising:
recording said manipulated frame onto a recording medium.

21. The method of claim 18, wherein said step of manipulating includes one of:
enlarging said selected frame;
cropping a portion of the selected frame by placing a border around a selected portion of said selected frame and storing said cropped portion of the selected frame; and
enlarging a portion of said selected frame enclosed by said border.

22. The method of claim 21 further comprising:
recording said cropped portion of the selected frame onto a recording medium.

23. The method of claim 1 further comprising:
recording said recordable content onto a recording medium;
reproducing said recorded content;
selecting a frame of said reproduced content for graphic manipulation; and
graphically manipulating said selected frame.

24. The method of claim 23 further comprising:
recording said selected frame onto a recording medium.

25. The method of claim 23 further comprising:
recording said manipulated frame onto a recording medium.

26. The method of claim 23, wherein said step of manipulating includes one of:
enlarging said selected frame;
cropping a portion of the selected frame by placing a border around a selected portion of said selected frame and storing said cropped portion of the selected frame; and
enlarging a portion of said selected frame enclosed by said border.

27. The method of claim 26 further comprising:
recording said cropped portion of the selected frame onto a recording medium.

28. A method for preventing the unauthorized use of a storage medium, said method comprising:
uniquely associating a personal versatile recording apparatus with said storage medium;
generating at least one descriptor, said at least one descriptor having a descriptor value that is unique to said versatile recorder apparatus and said storage medium;
attaching a signature to said at least one descriptor;
storing said descriptor and said signature within protected memory of said versatile recorder apparatus;
writing said at least one descriptor onto said storage medium as a hidden file reading said hidden file from said storage medium; and
authenticating said hidden file.

29. The method of claim 28 wherein said at least one descriptor is a single descriptor.

30. The method of claim 28 wherein said at least one descriptor is a plurality of descriptors.

31. The method of claim 28, wherein said at least one descriptor is encrypted using an encryption key contained within a personal versatile recording apparatus.

32. The method of claim 28 wherein said step of authenticating said hidden file further comprises:
authenticating said signature contained within said hidden file; and
comparing at least one descriptor contained within said hidden file with said at least one descriptor stored within said protected memory.

33. The method of claim 32 wherein said step of authenticating said signature further comprises:
comparing said signature contained within said hidden file with said signature stored within said protected memory.

34. The method of claim 28 further comprising:
marking said storage medium when said at least one descriptor contained within said hidden file fails to match said at least one descriptor stored within said protected memory.

35. The method of claim 28 further comprising:
marking said storage medium when said signature contained within said hidden file fails to match said signature stored within said protected memory.

36. The method of claim 28, wherein said step of reading said hidden file is performed under the direction of said personal versatile recorder apparatus.

37. The method of claim 28, wherein said step of reading said hidden file is performed under the direction of a system operator.

38. The method of claim 28, wherein said step of writing said descriptor file is performed when content is initially recorded onto said storage medium as a result of authorized first time use, said storage medium being previously unrecorded.

39. The method of claim 28, wherein said step of writing said descriptor file is performed when content is recorded after repair of said storage medium.

40. The method of claim 28, wherein no other personal versatile recording apparatus can generate said descriptor value.

41. The method of claim 28, wherein no other personal versatile recording apparatus can generate said signature.

42. The method of claim 28, wherein said hidden file is modifiable only by said versatile recorder apparatus that originally generated said descriptor file, a different personal versatile recording apparatus cannot modify said hidden file.

43. The method of claim 28, wherein said step of association prevents the unauthorized use of said storage medium by another set-top terminal or another personal video recorder.

44. The method of claim 28, wherein said step of association prevents the playback of content on said storage medium by said another set-top terminal or said another personal versatile recorder apparatus.

45. The method of claim 28, wherein said hidden file must be removed from said storage medium when said storage medium is used with a different pre-authorized personal versatile recorder apparatus.

46. A method for recording content using a personal versatile recording apparatus, the method comprising:
establishing a time duration for recording a hindmost portion of said content;
recording said hindmost portion of said content for said time duration, said hindmost portion of said content being instantaneously recorded on a recording medium.

47. The method of claim 46, wherein said step of establishing said time duration includes entering said time duration as a time default value where it remains as the established time duration for recording said hindmost portion of said content.

48. The method of claim 46, wherein said step of establishing said time duration includes entering said time duration for each individual said hindmost portion of said content is individually varied.

49. The method of claim 48, wherein said time duration is individually varied by establishing a record time duration for each hindmost portion to be recorded

50. The method of claim 48, wherein said time duration is individually varied by marking the start and endpoint of said content to be recorded.

51. A method for recording content using a personal versatile recording apparatus, the method comprising:
presenting an advertisement for said content, said advertisement indicating that said advertised content is to be presented at a scheduled time period on a content channel, said scheduled time period being a future time and a future date;
scheduling said advertised content for recording at said scheduled time period, said step of scheduling being performed without a manual entry of said content channel, said future time or said future date, or without the manual entry of a specific code representing said advertised content; and
recording said scheduled content during said scheduled time period onto a recording medium.

52. The method of claim 51, wherein said personal versatile recording apparatus performs said step of scheduling and said step of recording.

53. The method of claim 51, wherein said step of scheduling further comprises:
establishing said content channel as a record channel;
establishing said future time as a record time; and
establishing said future date as a record date.

54. The method of claim 53, wherein said step of recording further comprises:
tuning said personal versatile recording apparatus to said record channel; and
recording said scheduled content at said record time and said record date.

55. The method of claim 51, wherein said advertised content is content to be presented only on one occasion.

56. The method of claim 51, wherein said advertised content is an individual work from a collection of related content.

57. The method of claim 56, wherein said step of scheduling said advertised content for recording further comprising:
scheduling to record each said individual work of said collection of related content.
